(19) United States
(12) Patent Application Publication
(10) Pub. No.: US 2010/0318207 A1
(43) Pub. Date: Dec. 16, 2010

(54) SOURCING AGENT BASED PRODUCTION LOGISTICS MANAGEMENT METHOD AND SYSTEM INCLUDING ORDER ENTRY, TRACKING, AND FULLFILMENT

(75) Inventors: Peter C. YEE, Scotts Valley, CA (US); Maria L. YEE, Scotts Valley, CA (US); Yao WU, Fremont, CA (US)

Correspondence Address: Syncflo Holdings Limited, P.O. Box 7061, Fremont, CA, 94537, US

(73) Assignee: Syncflo Holdings Limited, Tortola (VG)

(21) Appl. No.: 12/484,884

(22) Filed: Jun. 15, 2009

(51) Int. Cl. G06F 19/00; G06Q 10/00; G06F 17/30

(52) U.S. Cl. 700/95; 705/28; 707/E17.044

(57) ABSTRACT

Container based oversight and management of orders for multi-component, fabricated articles. This is done by entering an order for multi-component, fabricated articles into a database and virtually associating the ordered multi-component, fabricated articles to a virtual transit container. The virtual transit container corresponds to a real transit container. The orders for the multi-component fabricated articles are either broken up into orders for components and subsequent fabrication, or the entire set of orders is transmitted to a sourcing agent. The sourcing agent virtually associates individual ones of the ordered multi-component, fabricated articles to their constituent components, and the sourcing agent orders the constituent components from one or more individual vendors. One or more fabricators receive the ordered constituent components and fabricate the constituent components into the ordered multi-component articles, packing the fabricated multi-components articles into the associated real transit containers. The real transit containers are then shipped along the distribution chain.

### FIELD OF THE INVENTION

The invention relates generally to a computerized system and method that enables a wholesaler, a distributor, or a purchaser to order one or more items at a location geographically separated from a system user with on-site virtual representation, oversight, and control provided an intermediary. This includes generating an itemized listing of the sub-components needed to be obtained from a vendor network for incorporation in the product. The system and method further provides for establishing, maintaining, and updating a record of stores of components and also for tracking a production process. The system and method also generates notices of payments due and accounts payable.

### BACKGROUND ART

International commerce has migrated to small businesses, including small merchandisers selling through small retailers and small manufacturers using networks component fabricators. One driver of this migration has been e-commerce over the internet, bringing designer and manufacturer, buyers and sellers, and intermediaries together into virtual face to face contact.

Another driver of this revolution in international commerce is “containerization.”

“Containerization” is the term that encompasses the industrial shipping process of packing goods into a container, typically a metal container, at the point of production and transporting the container and its contents as a unit until it is unpacked at its final destination. Containerization, per se has been around in various guises since the early nineteenth century, but it rapidly developed from a footnote in a 1956 cargo handling textbook, Marine Cargo Operations (Sauerbier 1956), to the observation of a 1971 Organisation for Economic Co-operation and Development (OECD) report that essentially all containerizable cargo on the transatlantic route was being carried in containers (Organisation for Economic Co-operation and Development 1971).

One effect of containerization has been to reduce the transportation costs associated with international marine transportation of merchandise. Initially, smaller manufacturers and merchandisers shipped “break bulk” with multiple orders from multiple manufacturers to multiple merchandisers. This required the intermediation of freight forwarders and freight consolidators at both ends of the voyage.

However, as manufacturing countries acquired increasing manufacturing sophistication, and as the internet based e-commerce enabled a greater degree of integration between independent product designers and end product merchandisers, it became economically viable for entire containers to be dedicated to an order or orders from a single manufacturer in the manufacturing country to a single merchandiser in the target country.

Moreover, the tools of e-commerce and containerization allow smaller merchandisers to participate in the international commerce area. These smaller merchandisers are not multi-nationals in the traditional sense. They do not have international or multinational product design, manufacturing, accounting, data processing, or transportation organizations of the traditional multi-nationals.

Thus, a clear need exists for the virtual integration of marketing, manufacturing, inventory, transportation and distribution, and accounting data into a user accessible database or databases with the grouping of product unit data into a physically realizable and visualizable set, aided by a sourcing agent.

### SUMMARY OF THE INVENTION

These and other objects are achieved by the method and system of our invention which provides for the virtual integration of marketing, ordering, manufacturing, inventory, transportation and distribution, and accounting data into a user accessible database or databases with the grouping of product unit data into a physically realizable and visualizable set, with the association of the data on a product unit by shipping container basis, that is, the basic order and tracking unit is the shipping container, with the association of the data on a product unit by shipping container basis. Moreover, the sourcing agent function provides on-scene support at vendor facilities.

According to the method and system of the invention orders for multi-component, fabricated articles are processed, tracked, overseen, and fulfilled. This is done by entering an order for a plurality of multi-component, fabricated articles into a database and virtually associating the ordered plurality of the multi-component, fabricated articles to a virtual transit container. The virtual transit container corresponds to a real transit container at a later stage of the process. The orders for the plurality of the multi-component fabricated articles are then either broken up into orders for components and subsequent fabrication, or the entire set of orders is transmitted to the sourcing agent. The oversight function is performed through a sourcing agent functionality, using associated databases, other databases, various query methodologies, including database federation and “Extract, Transform, and Load” (“ETL”) database management The sourcing agent virtually associates individual ones of the ordered plurality of the multi-component, fabricated articles to their constituent components, including the sourcing agent ordering or overseeing the ordering of the constituent components from one or more individual vendors. One or more fabricators receive the ordered constituent components and fabricate the constituent components into the ordered multi-component articles, and packs the fabricated multi-components articles into the associated real transit containers. The real transit containers are then shipped along the distribution chain.

A further aspect of the invention is a program product having a writable substrate with computer readable code thereon for configuring and controlling a computer system. The underlying computer system has a plurality of computers, each having a central processor unit, input/output means; and local memory. The system also includes a plurality of database servers having databases thereon capable of being associatively accessed to determine the status of an object. The object, which may be a representation of a product, a work in progress, an order, or the like, may be distributed over a plurality of the databases. The computer system is configured and controlled to carry out a method of processing, tracking, overseeing, and fulfilling orders for multi-component, fabricated articles by a process comprising the steps of:

a) entering an order for a plurality of the multi-component, fabricated articles into a database;

b) virtually associating the ordered plurality of the multi-component, fabricated articles to a virtual transit container corresponding to a real transit container;

c) transmitting the order for the plurality of the multi-component fabricated articles to a sourcing agent;

d) the sourcing agent virtually associating individual ones of the ordered plurality of the multi-component, fabricated articles to their constituent components;

e) the sourcing agent ordering the constituent components from vendors;

f) a fabricator receiving the ordered constituent components;

g) the fabricator fabricating the constituent components into multi-component articles;

h) the fabricator packing the fabricated multi-components articles into the associated real transit containers; and

i) shipping the real transit containers.

A further aspect of the invention is a computer system that is configured and controlled to carry out a method of receiving orders for multi-component, fabricated articles from purchasers, and processing, tracking, overseeing, and fulfilling orders for multi-component, fabricated articles from vendor networks of multiple vendors. The computer system comprises a plurality of individual computers, with each individual computer having a central processor unit, an input/output means; and local memory. The system also includes a plurality of database servers, where each of the said plurality of database servers is associated to an individual computer, and each of the database servers has databases capable of being accessed by a user at one of said individual computers to enter and update the status of an object or an attribute thereof, where the object has attributes distributed over a plurality of the databases. The system determines the status of an object, including an attribute thereof; and virtually packs fabricated orders into virtual shipping containers. The system also includes or associated to a plurality of internet servers associated to said database servers and individual computers to provide internet connectivity therebetween. In a preferred embodiment wherein one of the individual computers is associated to a sourcing agent, with the sourcing agent receiving orders for multi-component fabricated articles. Individual ones of the ordered plurality of the multi-component, fabricated articles are associated to their constituent components; with ordering of the constituent components from vendors; and virtually packing fabricated orders into virtual shipping containers. Virtual shipping containers track work in progress orders. The database may be a single database, multiple databases, or individual databases, federated to enter, update, or track a status of an order. Specifically the system is capable of processing, tracking, overseeing, and fulfilling orders for multi-component, fabricated articles by associating an order to a container, and tracking the container.

### THE FIGURES

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 illustrates the worldwide, internet e-commerce and containerized ocean transport environment of the method and system of our invention, showing a system with terminals, associated memory, where at least one terminal has dedicated memory for a sourcing agent functionality, data servers, web servers, communicating through the internet.

FIG. 2 illustrates a multi-terminal, system, including data servers and internet servers, for carrying out the method of our invention through a network. The terminals have I/O, memory, a CPU, and a net connection.

FIG. 3 is a high level flow chart of the method of our invention. The flow chart shows the initiating step of receiving and entering an order in the system of the invention including creating and opening an associated virtual shipping container for tracking and accounting, generating or retrieving stored design documents, fabricating one or more products, packing the fabricated products into associated real shipping container or containers corresponding to virtual shipping containers. The fabricated products are then shipped in the real shipping containers.

FIG. 4 is a matching flow chart to FIG. 3 but representing the document flow, that is, the documentary pathway of computer transactions according to the invention as shown in FIGS. 5 to 20.

FIG. 5 is an optional sign on screen for access by a customer.

FIG. 6 illustrates one version of a sign on screen indicating user searchable searches and screens.

FIG. 7 illustrates a directory of the order quotes, where the order quotes are typically entered directly by the customer or indirectly by the customer and a sales representative.

FIG. 8 illustrates a screen for entering an Order Quote. As shown in FIG. 3, creating an Order Quote may be the first step in the process of the invention.

FIG. 9 illustrates a screen shot of a completed Order Quote with SKU #'s (Stock Keeping Unit Numbers), reference numbers, product names, internal locations, volumes, and measures of volumes and weights.

FIG. 10 is an illustration of an Order Quote presented as a container view. This view shows the items in one order that are initially associated to one virtual shipping container for in process tracking, and thereafter transferred to a real shipping container.

FIG. 11 shows a Delivery Quote and represents a container load showing SKU, product name, local identifiers, quantities, priority, requested and confirmed FOB dates, virtual container ID, and manufacturers.

FIG. 12 illustrates a single screen shot of a Delivery Quote showing, in a single screen, Delivery Quote details, virtual container load, and real container load.

FIG. 13 illustrates a screen shot of virtual container contents, including, for example, delivery quote numbers, SKU #'s, and volumes.

FIG. 14 is a representation of a screen shot showing container loads with current container loads and purchase orders not yet assigned to a container, including container load number, FOB date, customer destination, and status. The screen shot also shows purchase orders to assign to a container load, with purchase order numbers, FOB date, destination, and status.

FIG. 15 is an illustration of a screen showing container load with purchase order number, SKU #, reference SKU #, reference purchase order number, quantities, priorities, volumes for the container.

FIG. 16 is a screen shot of a Ship Out List, showing purchase order number, SKU number, reference SKU #, Reference purchase order number, quantity, container number, and package volumes.

FIG. 17 is a screen shot of an order directory showing elements of an order history.

FIG. 18 is a screen shot of a purchase order including customer information, commercial terms and conditions, and order contents.

FIG. 19 illustrates a screen shot of a customer purchase order director, with purchase order numbers, customer ID's, and customer names.

FIG. 20 illustrates another version of a customer purchase order.

FIG. 21 illustrates a general flow chart with representations of virtual packages, a virtual shipping container, and real containers packed into a real shipping container.

FIG. 22 illustrates a high level overview of database federation and “Extract, Transform, and Load” (“ETL”) database management to query, search, and selectively extract data, present the data, analyze and present the data using complex optimization, for example, integer programming, mixed integer programming, heuristics, and artificial intelligence, among other techniques, human intervention and requesting additional data, as carried out by a sourcing agent.

### DETAILED DESCRIPTION

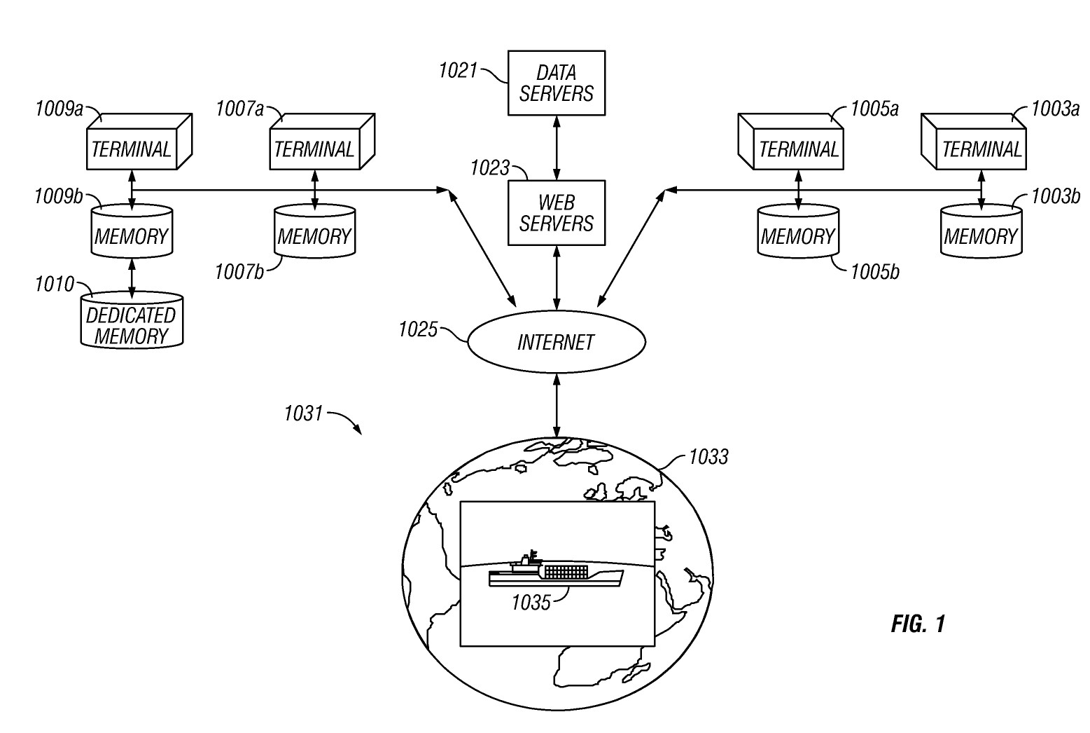

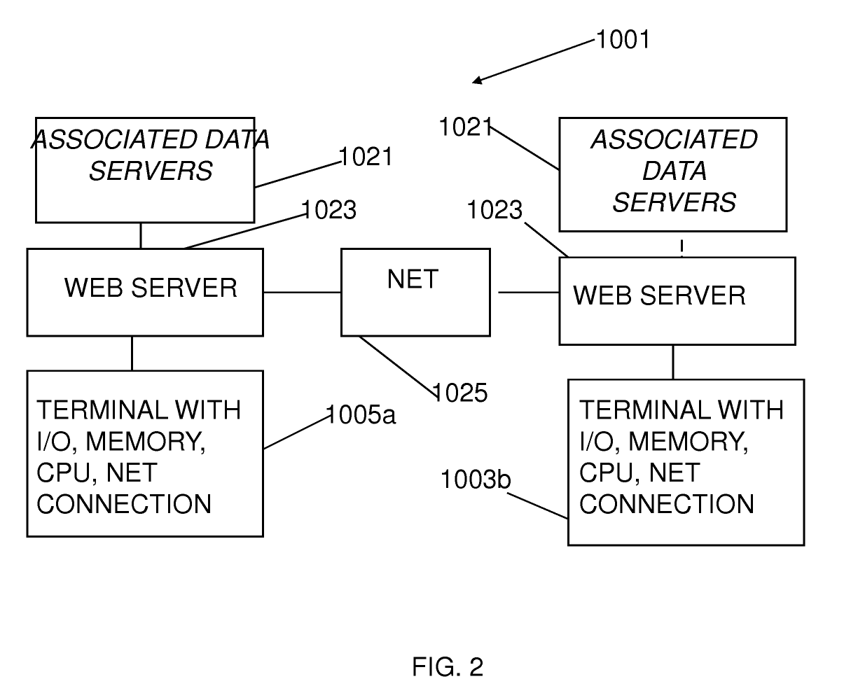

With reference now to the figures and in particular with reference to FIGS. 1 and 2, exemplary diagrams of data processing environments are provided, in which illustrative embodiments may be implemented. It should be appreciated that the Figures are only exemplary and are not intended to assert or imply any limitation with regard to the environments, in which different embodiments may be implemented. Many modifications to the depicted environments may be made.

FIG. 1 illustrates the a system 1001 and method in the context of a worldwide, internet 1025 e-commerce and containerized ocean transport environment for practicing the method and using the system 1001 of our invention. FIG. 1 further illustrates the worldwide, internet e-commerce 1025 characterized by the containerized ocean transport 1031 environment of the method and system 1001 of our invention where a sourcing agent may optionally be present.

The system 1001 provides individual computer terminals 1003a, 1005a, 1007a, and 1009a, with associated memories 1003b, 1005b, 1007b, and 1009b, optionally including a dedicated and secure memory 1010 for the sourcing agent, when present. The system 1001 includes data servers 1021 and web servers 1023 to communicate through an internet 1025, thereby facilitating international commerce in a marine cargo container environment 1031, illustrated with a container ship 1035 traversing an ocean 1033.

According to the invention described herein, virtually integrating marketing, ordering, manufacturing, inventory, transportation and distribution, and accounting data into a user accessible database or databases is carried out, with the virtual grouping of product unit data into virtual model of a physically realizable and visualizable set, and with the association of the data on a product unit by shipping container basis, that is, how many of each product unit in an order are packed into a particular shipping container.

FIG. 2 illustrates a multi-terminal, system, including data servers and internet servers, for carrying out the method of our invention. FIG. 2 illustrates terminals 1003a and 1003b, with I/O. memory, CPU, and a net connection. The terminals are connected through web servers 1023 to an internet 1025, with associated data servers 1021.

Container Driven

The method and system of the invention is based on a business model and an associated workflow system that integrate e-commerce and containerization. The business model and workflow system integrates order processing (paperwork flow), product design/development flow, order “consolidation” and containerized logistics through a sourcing agent. As used herein a container is broadly described and claimed as an ocean shipping container, truck trailer, air cargo pallet, or the like.

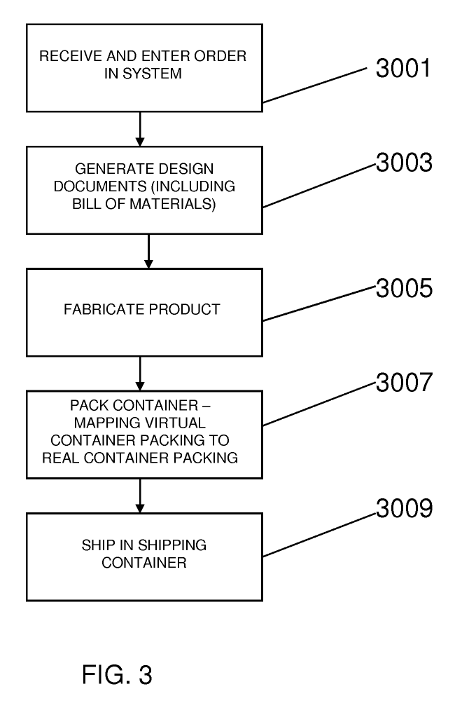

FIG. 3 is a high level flow chart of the method of our invention. The flow chart shows the initiating step of receiving and entering an order 3001 in the system of the invention including creating and opening an associated virtual shipping container for tracking and accounting 3002, generating or retrieving stored design documents 3003, fabricating one or more products 3005, packing the fabricated products into associated real shipping container or containers corresponding to virtual shipping containers 3007. The fabricated products are then shipped 3009 in the real shipping containers.

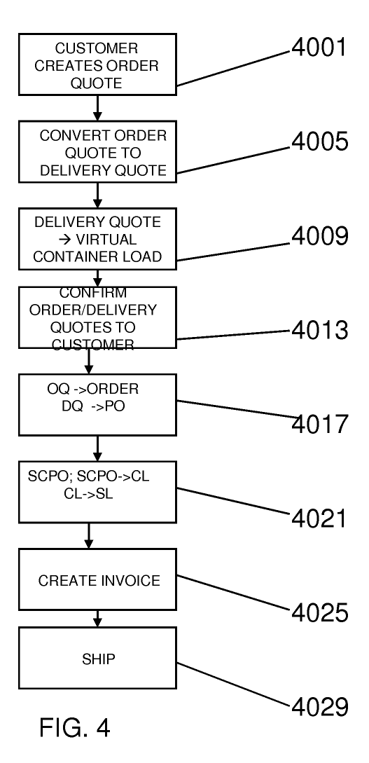

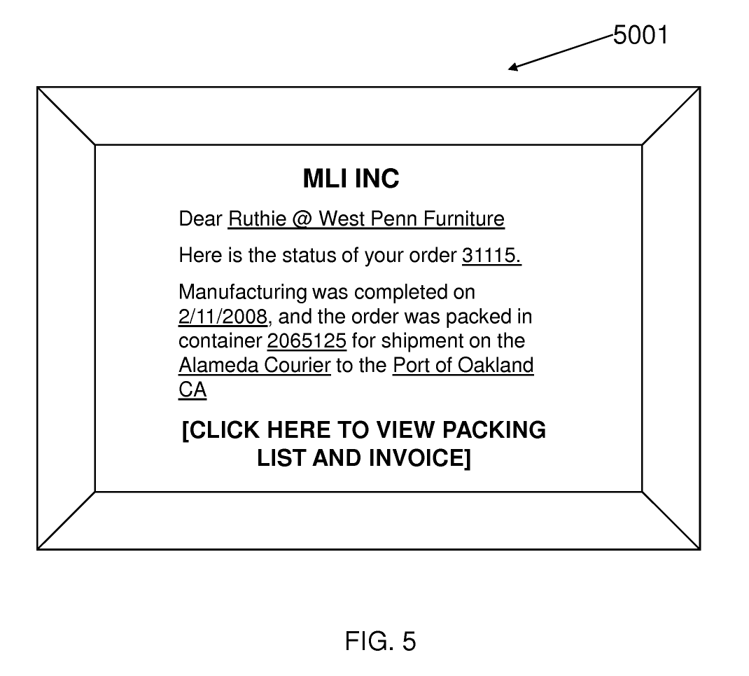

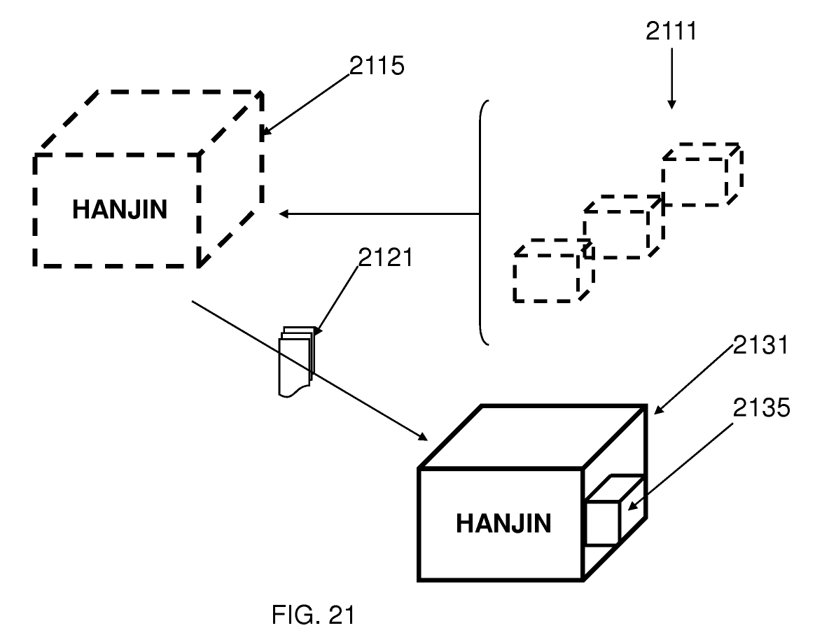

FIG. 4 is a matching flow chart to FIG. 3 representing the document flow, that is, the documentary pathway of computer transactions according to the invention as shown in FIGS. 5 to 20. FIG. 4 illustrates the sequence of the customer creating an order quote 4001, converting the order quote to a delivery quote, and converting the delivery quote to a virtual container load 4009 (and illustrated in FIG. 21). The order and delivery quote are then confirmed to the customer 4013, and converted to a purchase order 4017. Next a sourcing company purchase order is created, transformed into a container load, and the container load converted into a ship out list, 4021. The real container is then loaded and then shipped 4029.

FIG. 21 illustrates a general flow chart with representations of virtual packages, a virtual shipping container, and real containers packed into a real shipping container.

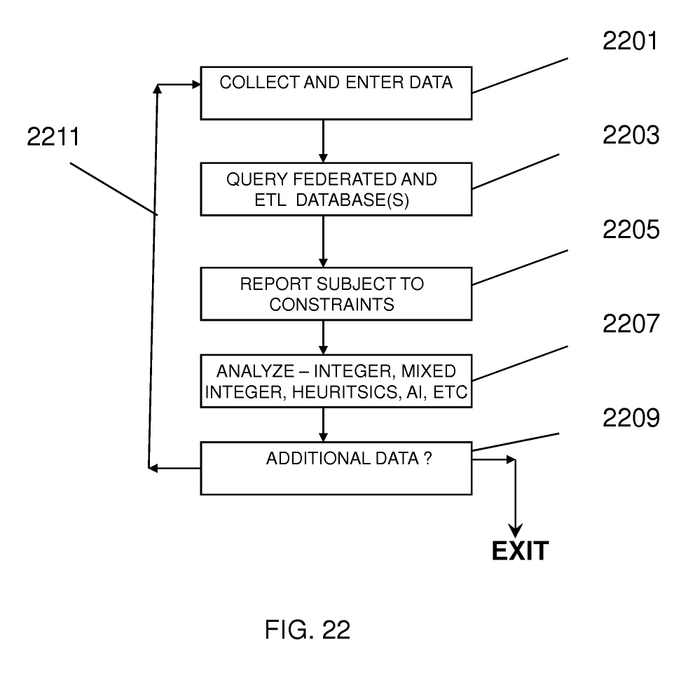

A target user of the virtual container and the associated real container as a management tool is the sourcing agent. The sourcing agent uses query tool and decision tools, such as those in FIG. 22. FIG. 22 illustrates a high level overview of database federation and “Extract, Transform, and Load” (“ETL”) database management to query, search, and selectively extract data, present the data, analyze and present the data using complex optimization, for example, integer programming, mixed integer programming, heuristics, and artificial intelligence, among other techniques, human intervention and requesting additional data, as carried out by a sourcing agent.

In a preferred embodiment the method and system of our invention incorporates and links to container filling algorithms. This enables the virtual container to be filled as orders are processed, for example upon receipt of the Order Quote or generation of the purchase order or orders to the vendor network.

In a still further embodiment, a link to associated “business software” such as customer relationship management software, detailed order entry and tracking software, e.g., for p.o. tracking from customers, invoices to customers, payment tracking from customers, p.o. tracking to vendors (e.g., through “sourcing agents” as will be described hereinbelow, to vendors and subvendors), invoices receiving from vendors and subvendors, payments to vendors and subvendors, shipping documents, customs documents, notifications to customers. The business software may exchange data with associated databases or may be integrated into the over riding software.

The method, system, and business model includes provisions for either or all of (1) outsourcing of “detailed design” (fabrication type CAD/CAM files), associated QC tools, packaging plans, packing containers procedures to a vendor network, or (2) high level design of the finished product and detailed design of constituent components can be performed inhouse by the distributor or importer, or (3) high level design of the finished product can be performed inhouse by the distributor or importer, with the detailed design of constituent components being performed by the vendors and subvendors in the vendors networks.

The method and system of the invention is “Container Driven” where the software representation of the “container,” the virtual container 2115 illustrated in FIG. 21, has built-in intelligence and downstream applicability. The intelligence and downstream applicability may be provided by treating the “container” as an object in an object oriented programming software package, with the virtual container 2115 contents 2121 and container properties as attributes of the container object. This is illustrated generally in FIGS. 3, 4, and 5, which shows the sequence of the planning, design, fabrication, and shipping steps, where the production sequence is driven by attributes of the container object and attributes of the contents objects, and in FIG. 21 which shows the real and actual container and contents.

The method and system of the invention addresses the issue of the barriers to small enterprise international commerce posed by the designer and merchandiser being “half a world away” from the vendor network and fabricators, separated by distance, oceans, language, and culture. This is where the “Sourcing Agent” comes in.

FIG. 1 is a high level flow chart of the sourcing agent of our invention. As illustrated in FIG. 1, the “Sourcing Agent” may be a dedicated block of memory, for example with limited access and visibility. The “Sourcing Agent” can be real or virtual, and can be a function of the distributor on the receiving end of the stream of commerce, the importer, an assembler in the country of origin, the shipping company, or a financial intermediary. In the case of a virtual “sourcing agent” or a minimalist “sourcing agent”, the “sourcing agent” can be a software module, with a virtual representation of the container moving back and forth electronically from manufacturer to “sourcing agent” to the distributor. In one embodiment the Sourcing Agent can be dedicated computer code, typically resident on and only accessible by one terminal, as illustrated by element 1010 in FIG. 1. This dedicated code performs one or more of contracting vendors, ordering components, packing into virtual containers, and overseeing billing and collections.

The Sourcing Agent can be an independent entity, or affiliated with the “designer” or a “marketer” or a “manufacturer” or a group of such entities. Alternatively, the Sourcing Agent can be affiliated with the fabricator, the component vendor, or a group of such entities, or even a shipping company or financial services company or a consortium of shipping companies, financial service companies, freight forwarders, or the like.

The “sourcing agent” can be a real “sourcing agent”—or a virtual “sourcing agent” and can be located anywhere, Hong Kong, Seoul, Tokyo, Singapore, or a tax haven such as Bermuda, Monte Carlo, or the Caribbean. It can be a computer terminal on a desk or a virtual memory on a server.

The “sourcing agent” performs an oversight function and a vital intermediary, middleman, and local agent function. In practice, the “sourcing agent” receives an order from the distributor, generally in the US, and orders the merchandise from the manufacturer, for example, in the PRC. The manufacturer manufactures the items and virtually, but not physically, ships them from the factory, generally, in the PRC, to the “sourcing agent” (for example, in Hong Kong) to the distributor (for example, in the US).

The “sourcing agent” can also purchase goods and services on behalf of the “distributor” a multi vendor “vendor network” in, for example, the PRC.

In practice the US distributor generates (or transmits a retailer generated) purchase order to the “sourcing agent”. In the same transaction or in a real time transaction (with human interaction and judgment) the sourcing agent generates a purchase order to either or both of the manufacturer and the vendor network.

The flow of funds can be totally electronic, from the (US) distributor to the “sourcing agent” and from the “sourcing agent” to the vendor network and manufacturer, and can be in the form of electronic fund transfers and letters of credit, with receipts, and shipping documents going back to the (US) distributor the same way.

One aspect of the role and functionality of the sourcing agent as described herein utilize the capabilities of databases associated to the parties. The database(s) are preferably “Shared Databases.” That is, the databases can be a single database and the single database may be distributed across multiple servers or duplicated across multiple servers or resident on a single server. Alternatively the databases may be federated database(s). What is necessary is that the participants have the requisite ability, accessibility, or visibility to access and search databases.

The database(s) may contain product development data, such as image data file or CAD files. The database(s) may also contain sourcing agent data, supplier/fabricator data, including subcomponent and subvendor data, protected by visibility and accessibility controls. Having the data in a small number of repositories as opposed to passing data back and forth reduces or even eliminates opportunities for corruption of data by reducing redundant computer transactions and net passing data back and forth, and also reduces “turn around time” from product conception to product delivery, i.e., market cycle time.

Process Flow

According to one exemplification of the method and system of our invention, an order comes in, e.g., for 100 tables and 500 chairs. The distributor receives this order, verifies credit and customer relationship history, and then decides how to ship, i.e., a single container or several containers. In the case of a large number of containers the last several containers may not be full.

The distributor does not send a PO first, but instead tries to “pre-configure” the order into a virtual shipping container, that is, using estimated unit cubages and weights, and a container packing algorithm. Generally, the integrator, or fabricator does the container configuration.

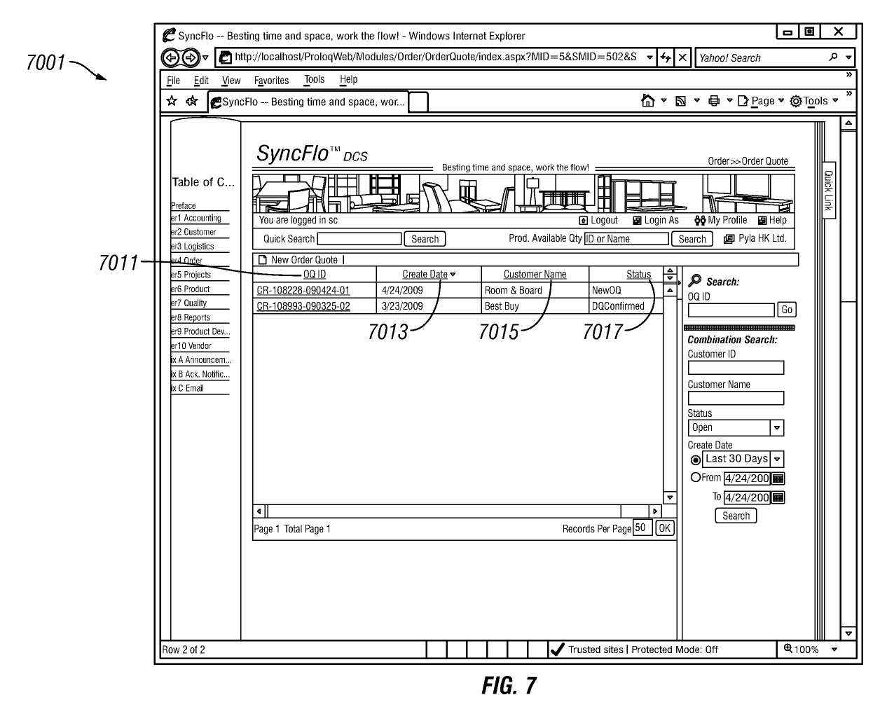

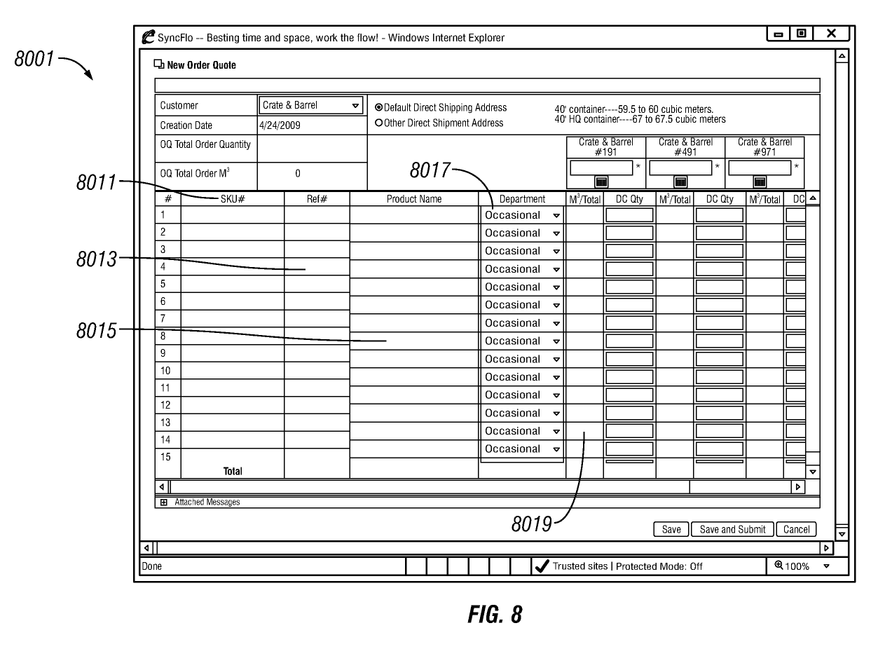

The distributor then sends this information back to the customer, such as the Preorder of FIG. 7 and the Container View of FIG. 8, as a form of detailed offer or a counteroffer such as,
1. I will add N units to fill Y containers, or
2. I will drop M units to fill X containers.

The customer places a PO for a container with the promised FOB date, number of containers, number of units and the distributor gets paid when the container arrives.

One container is, usually, and totally, for one customer, and the PO is placed on a “container” basis. An invoice is issued, for example, a set of invoices, to match purchase orders to container content to invoices. This may be done in software as a part of the business method. The PO and the associated invoices are “associated,” that is, “matched” to a container, so that the customer knows in advance which container(s) will contain which order(s), that is, a customer knows the mapping of PO/Invoice to container.

Intermediaries “mirror” the orders up and down the distribution chain. Intermediaries, as used herein, include banks, financial intermediaries, brokers, customs brokers, freight forwarders, and the sourcing agent of the invention.

Another intermediary may be a “jobber” performing a “Jobber” function or “consolidator” functions. Note that managing orders at a “container” level for larger orders, and the “consolidator” or “jobber” extends this benefit to smaller orders. The jobber combines small, sub-container, orders into a container level order. This may be a function performed by or at or under the direction of the “sourcing agent,” or under the direction of the wholesaler or distributor. Thus, the order to a fabricator or manufacturer may be to “Ship to Jobber” to “repackage” the order from a sub-container size lot to a container size lot.

FIG. 5 illustrates a sign on screen that is presented to a customer.

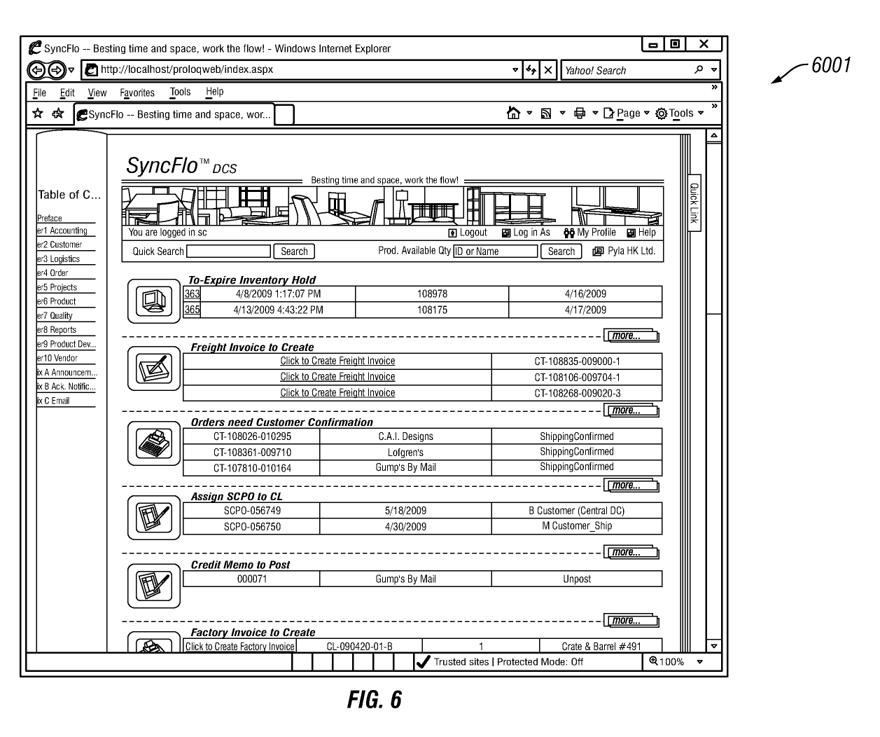

FIGS. 6 to 20 illustrate the paperwork flow of a method of the invention.

FIG. 6 illustrates one version of a sign on screen indicating user searchable searches and screens 6001. It is to be understood that a customer has limited access to the databases, with access and visibility verified by a user ID and a password, and the customer being limited to a set of pre-written and formatted queries. The customer ID portion of a query is determined by the customer's sign on.

FIGS. 7 through 20 illustrate responses to various queries. It is to be understood that users may, if authorized, submit queries, where the customer ID portion of a query is determined by the customer's sign on. The screen shots of FIGS. 7 through 20 represent responses to pre-written queries with formatting.

FIG. 7 illustrates a directory 7001 of the order quotes grouped by customer, where the order quotes are typically entered directly by the customer or indirectly by the customer and a sales representative. The display indicates order id's 7011, the order create date 7013, the customer name 7015, and an order name 7017.

FIG. 8 illustrates a screen 8001 for entering an Order Quote. As shown in FIG. 3, creating an Order Quote may be the first step in the process of the invention. Fields provided include SKU #8011, reference number 8013, product name 8015, department 8017, and packing and shipping data 8019.

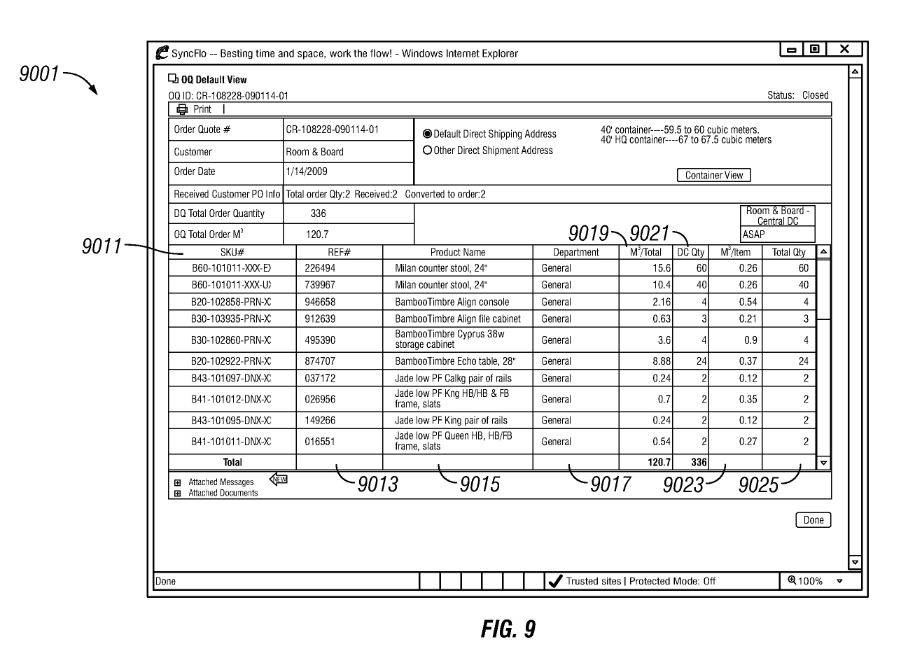

FIG. 9 is the result 9001 of the data submitted in the Order Quote of FIG. 8, illustrating a screen shot of a completed Order Quote with SKU #'s (Stock Keeping Unit Numbers) 9011, reference numbers 9013, product names 9015, internal locations 9017, and volumes and measures of volumes and weights 9019, 9021, 9023, and 9025.

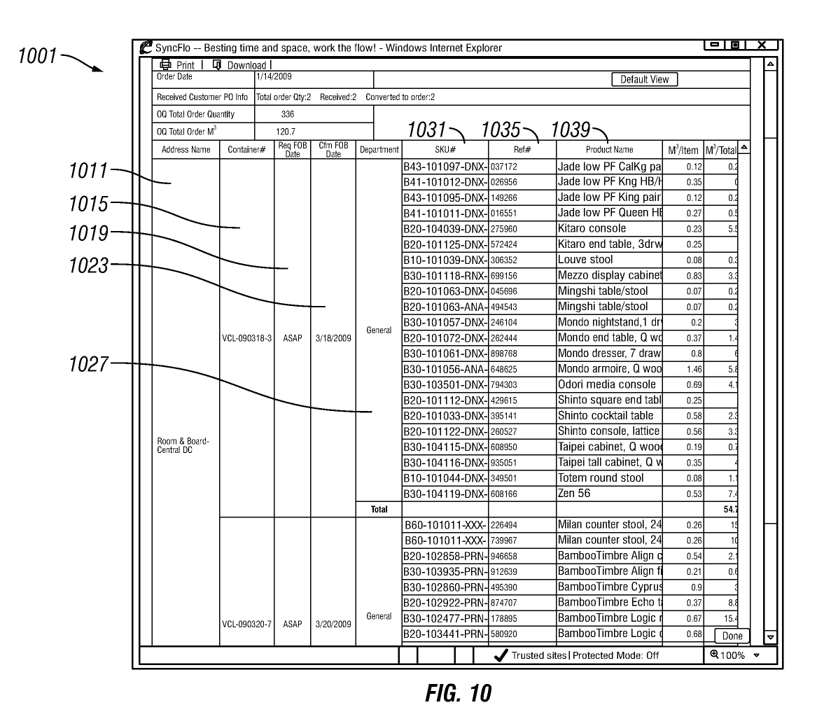

FIG. 10 is an illustration of an Order Quote 1001, presented as a container view. This view shows the items in one order that are initially associated to one virtual shipping container for in process tracking, and includes an address 1011, container ID 1015, requested FOB date 1019, FOB date 1023, Department 1027, SKU #1031, Reference Number 1035, and Product 1029. The listed items are thereafter transferred to a real shipping container.

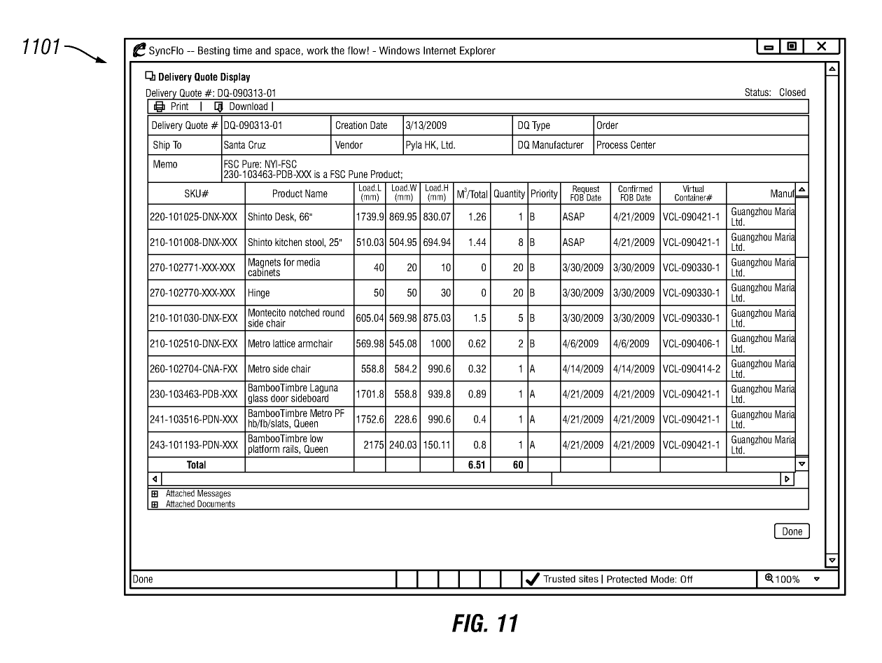

FIG. 11 shows a Delivery Quote 1101 and represents a container load showing SKU, product name, local identifiers, quantities, priority, requested and confirmed FOB dates, virtual container ID, and manufacturers.

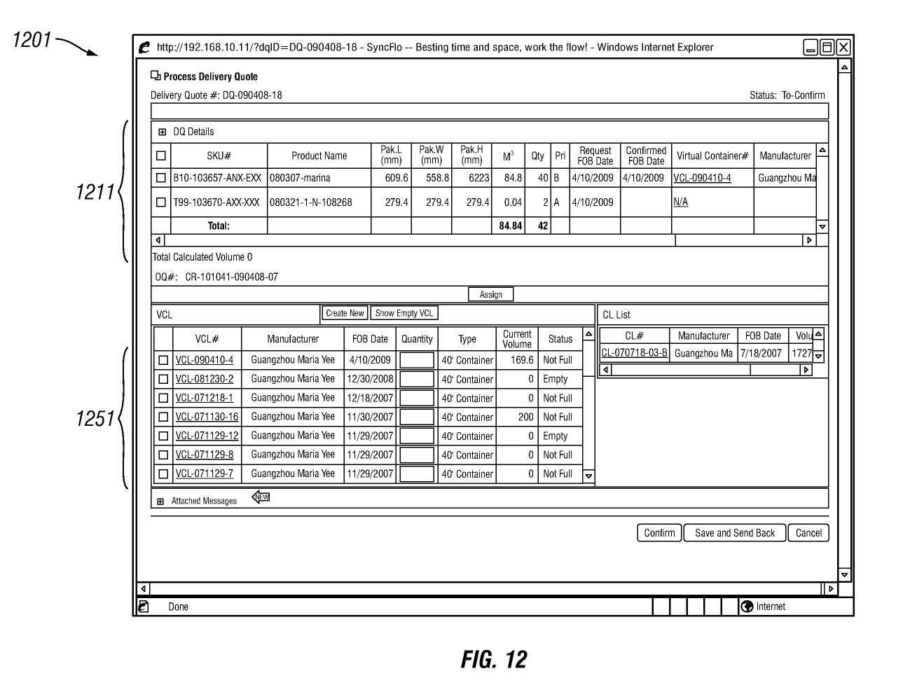

FIG. 12 illustrates a single screen shot of a Delivery Quote 1201 showing, in a single screen, Delivery Quote details 1211, and virtual container load 1251.

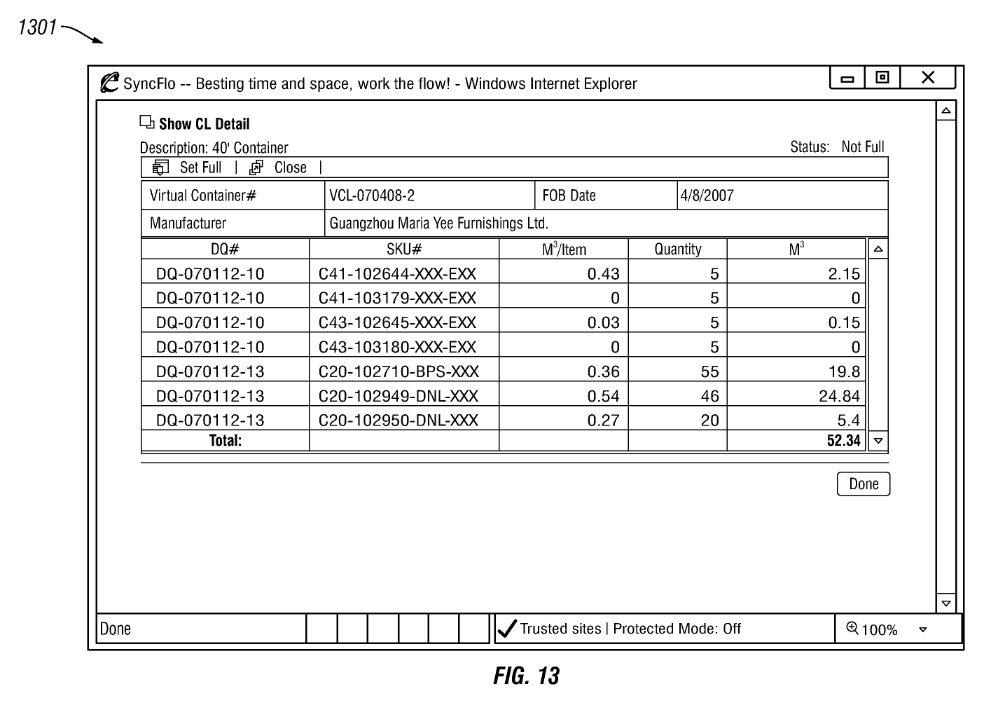

FIG. 13 illustrates a screen shot of virtual container contents 1301, including, for example, delivery quote numbers, SKU #'s, and volumes.

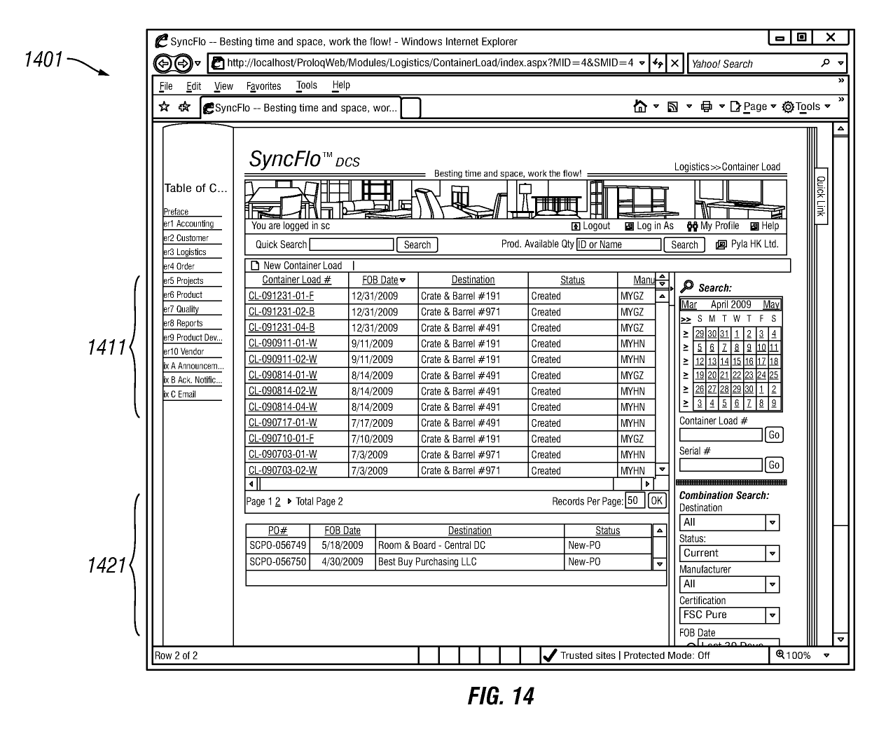

FIG. 14 is a representation of a screen shot showing container loads 1401, with current container loads 1411, and purchase orders not yet assigned to a container 1421, including container load number, FOB date, customer destination, and status. The screen shot also shows purchase orders to assign to a container load, with purchase order numbers, FOB date, destination, and status.

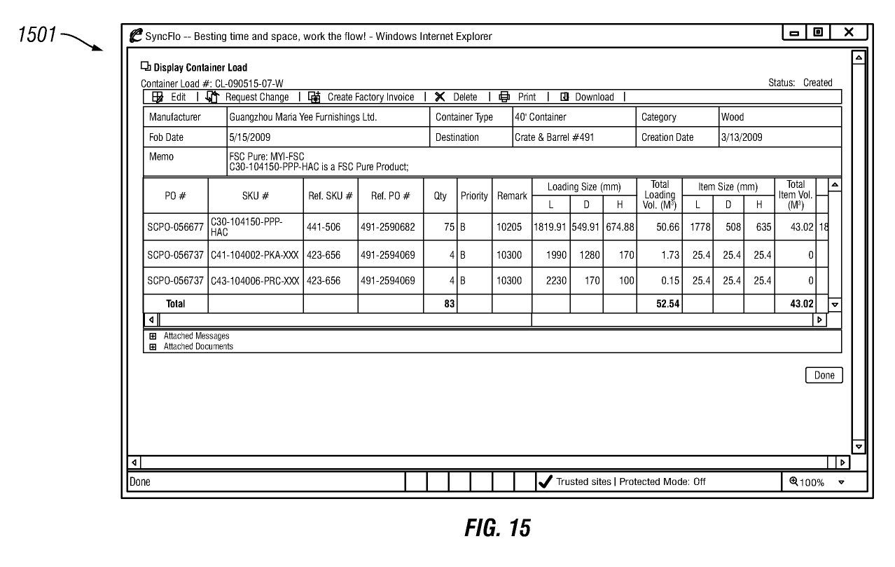

FIG. 15 is an illustration of a screen shot of a container load showing container load 1501, with purchase order number, SKU #, reference SKU #, reference purchase order number, quantities, priorities, volumes for the container.

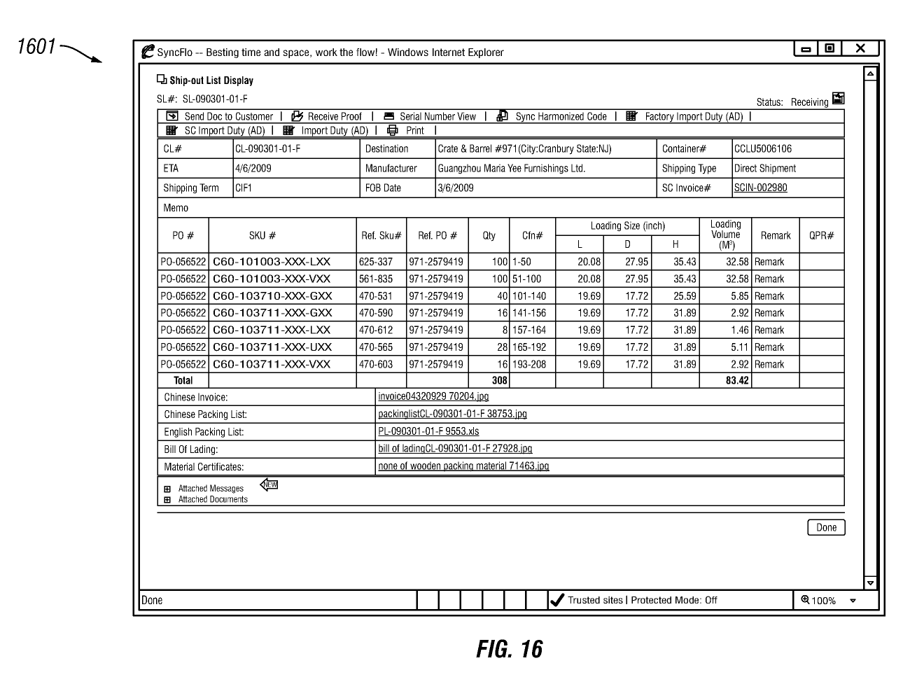

FIG. 16 is a screen shot of a Ship Out List 1601, showing purchase order number, SKU number, reference SKU #, Reference purchase order number, quantity, container number, and package volumes.

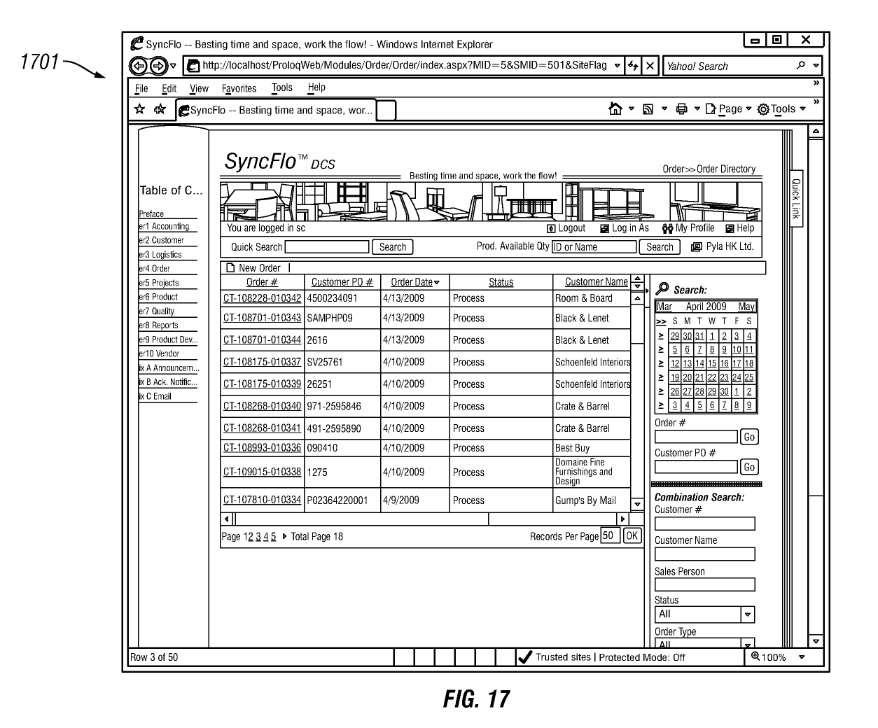

FIG. 17 is a screen shot of an order directory 1701, showing elements of an order history.

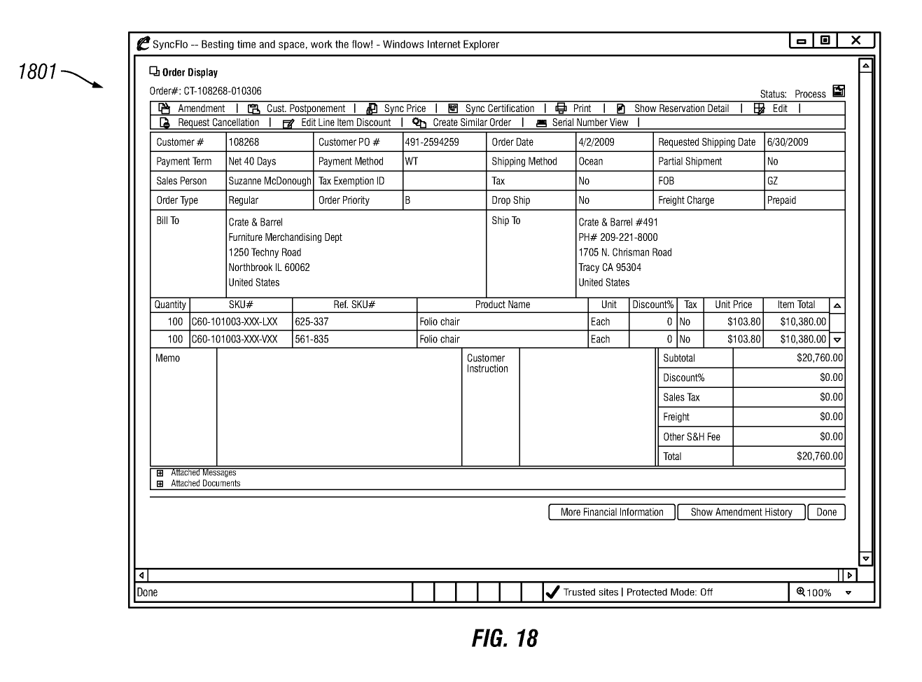

FIG. 18 is a screen shot of a purchase order 1801, including customer information, commercial terms and conditions, and order contents.

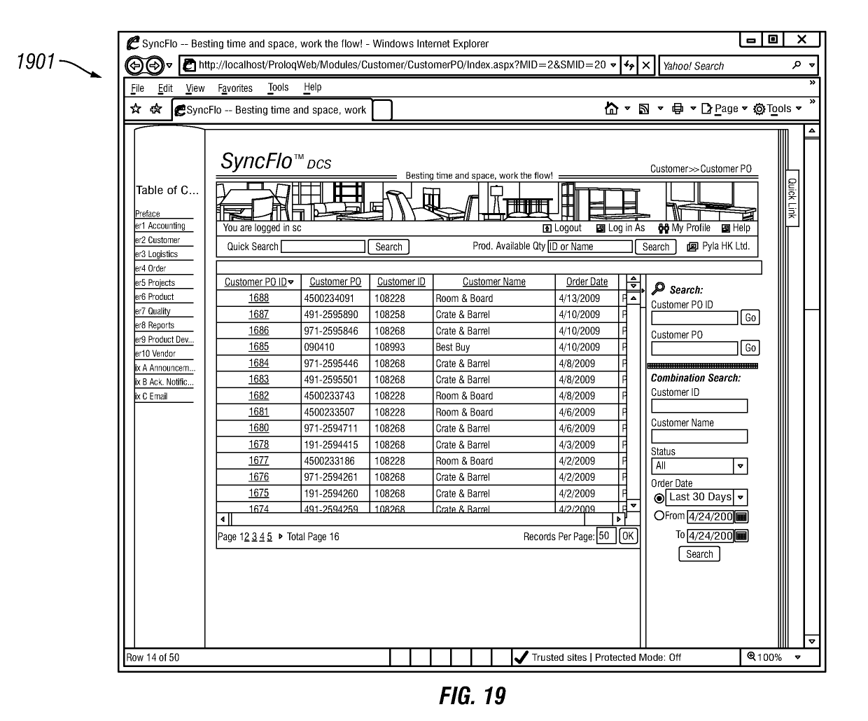

FIG. 19 illustrates a screen shot of a customer purchase order directory 1901, with purchase order numbers, customer ID's, and customer names.

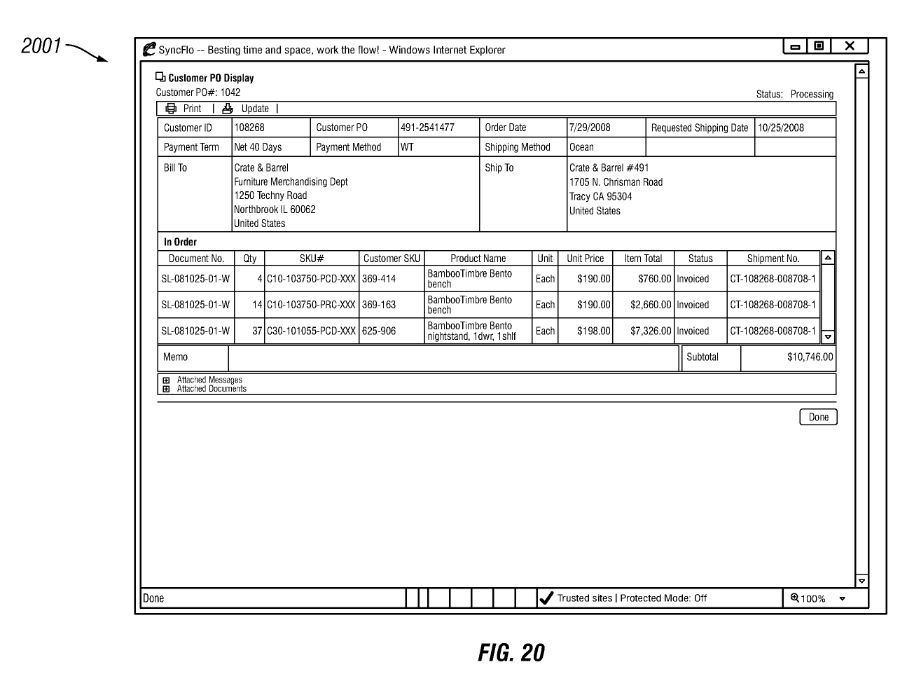

FIG. 20 illustrates another version of a customer purchase order 2001.

Process Path

The orders are ordered by “container,” that is, by shipping container, and the sourcing agent and fabricator receive orders on a container basis and arrange production by “container.” Production scheduling is ordered by container and the sub-vendor network is tracked by “containers” of fabricated finished product. This enables the sourcing agent, the distributor, and the customer to track manufacturing progress by “container” and spot delays on special orders, in a form of supply chain transparency.

According o the method and system of our invention information is ordered, grouped, and retrievable by “container” where orders are batched by manufacturing process, design, customer, etc. and tracked and ship by container.

At a granular level, each individual product is marked with container number (e.g., bar code). The finished product is then tracked and shipped by container number.

We get to a “delivery quote” which is sent to a factory and creates a new “virtual container”, and assigns the ordered merchandise to the “virtual container.” The customer can access and view the “Container View” display—but can not change it. This, in turn, generates (1) a Ship Order List where container loads are mapped into Ship Order List, and (2) a Serial Number Bill where serial numbers are mapped to containers and forwarded to a customer. The “Container View” also generates invoices and shipping documents for proof of delivery, letters of credit, and customs declarations.

The method of the invention may be further facilitated by database federation. A federated database system is a type of meta-database management system (DBMS) which transparently integrates separate, distinct, multiple autonomous database systems into a single federated database. The constituent databases are interconnected via computer networks, the internet, local area networks, and virtual networks and are frequently geographically decentralized. Since the constituent database systems remain autonomous, a federated database system is an alternative to the non-trivial task of merging together several disparate databases.

Through data abstraction, wrapper functions, and container functions, federated database systems preferably provide a uniform front-end user interface, enabling users to store and retrieve data in multiple databases with a single query, even if the constituent databases are heterogeneous. In order to accomplish this result, a federated database system must be able to deconstruct the query into subqueries for submission to the relevant constituent DBMS's after which the system must consolidate or aggregate the result sets of the subqueries.

Because various database management systems employ different query languages, federated database systems must frequently apply wrappers to the subqueries to translate them into the appropriate query languages.

In one embodiment the method, system, and program product of our invention utilize database federation and “Extract, Transform, and Load” (“ETL”) database management to query, search, and selectively extract data, analyze the data, present the data.

In actual computation interim databases are built, using temporary tables, associative tables on different tables on different dbms systems in the federated system. As soon the query is run on the federated system and reported, the temporary tables are locked or otherwise disappear. With federated data, the entire totality of the data need only be materialized during computation, and the finished product is only aggregated data, as only totals and statistics.

If a federated system is transparent, it masks from the user the differences, idiosyncrasies, and implementations of the underlying data sources, for example component designers, fabricators, shippers, and integrators. Ideally, it makes the set of federated sources look to the user like a single system. The user, for example a distributor or a sourcing agent, should not need to be aware of where the data is stored (location transparency), what language or programming interface is supported by the data source (invocation transparency), if SQL is used, what dialect of SQL the source supports (dialect transparency), how the data is physically stored, or whether it is partitioned and/or replicated (physical data independence, fragmentation and replication transparency), or what networking protocols are used (network transparency). The user should see a single uniform interface, complete with a single set of error codes (error code transparency).

A further aspect of federation is heterogeneity. Heterogeneity is the degree of differentiation in the various data sources. Sources can differ in many ways. They may run on different hardware, use different network protocols, and have different software to manage their data stores. They may have different query languages, different query capabilities, and even different data models. They may handle errors differently, or provide different transaction semantics. They may be as much alike as two Oracle instances, one running Oracle 8i, and the other Oracle 9i, with the same or different schemas. Or they may be as diverse as a high-powered relational database, a simple, structured flat file, a web site that takes queries in the form of URLs and spits back semi-structured XML according to some DTD, a Web service, and an application that responds to a particular set of function calls.

In a federated system, new sources may be needed to meet the changing needs of the users' business. Federation makes it easy to add new sources. The federated database engine accesses sources via a software component know as a wrapper. Accessing a new type of data source is done by acquiring or creating a wrapper for that source. The wrapper architecture enables the creation of new wrappers. Once a wrapper exists, simple data definition (DDL) statements allow sources to be dynamically added to the federation without stopping ongoing queries or transactions.

A still further aspect of federation is autonomy for data sources. Typically a data source has existing applications and users. It is important, therefore, that the operation of the source is not affected when it is brought into a federation. Existing applications will run unchanged, data is neither moved nor modified, and interfaces remain the same. The way the data source processes requests for data is not affected by the execution of global queries against the federated system, though those global queries may touch many different data sources. Likewise, there is no impact on the consistency of the local system when a data source enters or leaves a federation.

The description of the present invention has been presented for purposes of illustration and description, and is not intended to be exhaustive or limited to the invention in the form disclosed. Many modifications and variations will be apparent to those of ordinary skill in the art. The embodiment were chosen and described in order to best explain the principles of the invention, the practical application, and to enable others of ordinary skill in the art to understand the invention for various embodiments with various modifications as are suited to the particular use contemplated.

We claim:

1. A method of processing, tracking, and fulfilling orders for multi-component, fabricated articles comprising the steps of:
a) entering an order for a plurality of the multi-component, fabricated articles into a database;
b) virtually associating the ordered plurality of the multi-component, fabricated articles to a virtual transit container corresponding to a real transit container;
c) transmitting the order for the plurality of the multi-component fabricated articles to a sourcing agent;
d) the sourcing agent virtually associating individual ones of the ordered plurality of the multi-component, fabricated articles to their constituent components;
e) the sourcing agent ordering the constituent components from vendors;
f) a fabricator receiving the ordered constituent components;
g) the fabricator fabricating the constituent components into multi-component articles;
h) the fabricator packing the fabricated multi-components articles into the associated real transit containers; and
i) shipping the real transit containers.

2. The method of claim 1 of processing, tracking, and fulfilling orders for multi-component, fabricated articles wherein a marketer enters the order.

3. The method of claim 1 of processing, tracking, and fulfilling orders for multi-component, fabricated articles wherein the sourcing agent is a marketer.

4. The method of claim 1 of processing, tracking, and fulfilling orders for multi-component, fabricated articles wherein the sourcing agent is independent of the marketer.

5. The method of claim 2 of processing, tracking, and fulfilling orders for multi-component, fabricated articles wherein the sourcing agent is affiliated with the marketer.

6. The method of claim 1 of processing, tracking, and fulfilling orders for multi-component, fabricated articles wherein the database is a single database.

7. The method of claim 1 of processing, tracking, and fulfilling orders for multi-component, fabricated articles wherein the database comprises multiple databases.

8. The method of claim 7 of processing, tracking, and fulfilling orders for multi-component, fabricated articles comprising federating the databases to track a status of an order.

9. The method of claim 7 of processing, tracking, and fulfilling orders for multi-component, fabricated articles comprising accessing the individual databases to track a status of an order.

10. The method of claim 1 of processing, tracking, and fulfilling orders for multi-component, fabricated articles comprising associating an order to a container, and tracking the container.

11. A method of processing, tracking, and fulfilling orders for multi-component, fabricated articles comprising the steps of:
a) entering an order for a plurality of the multi-component, fabricated articles into a database;
b) virtually associating the ordered plurality of the multi-component, fabricated articles to a virtual transit container corresponding to a real transit container;
c) transmitting the order for the plurality of the multi-component fabricated articles to a sourcing agent;
d) the sourcing agent virtually associating individual ones of the ordered plurality of the multi-component, fabricated articles to their constituent components;
e) the sourcing agent ordering the constituent components from vendors;
f) a fabricator receiving the ordered constituent components;
g) the fabricator fabricating the constituent components into multi-component articles;
h) the fabricator packing the fabricated multi-components articles into the associated real transit containers; and
i) shipping the real transit containers.

12. The method of claim 11 of processing, tracking, and fulfilling orders for multi-component, fabricated articles wherein a marketer enters the order.

13. The method of claim 11 of processing, tracking, and fulfilling orders for multi-component, fabricated articles wherein the sourcing agent is a marketer.

14. The method of claim 11 of processing, tracking, and fulfilling orders for multi-component, fabricated articles wherein the sourcing agent is independent of the marketer.

15. The method of claim 11 of processing, tracking, and fulfilling orders for multi-component, fabricated articles wherein the sourcing agent is affiliated with the marketer.

16. The method of claim 11 of processing, tracking, and fulfilling orders for multi-component, fabricated articles wherein the database is a single database.

17. The method of claim 11 of processing, tracking, and fulfilling orders for multi-component, fabricated articles wherein the database comprises multiple databases.

18. The method of claim 17 of processing, tracking, and fulfilling orders for multi-component, fabricated articles comprising federating the databases to track a status of an order.

19. The method of claim 17 of processing, tracking, and fulfilling orders for multi-component, fabricated articles comprising accessing the individual databases to track a status of an order.

20. The method of claim 11 of processing, tracking, and fulfilling orders for multi-component, fabricated articles comprising associating an order to a container, and tracking the container.

21. The method of claim 11 further comprising production planning and tracking.

22. A program product comprising a computer writable substrate having computer readable code thereon for configuring and controlling a computer system, said computer system comprising:
1) a plurality of computers, each having a central processor unit, input/output means; and local memory
2) a plurality of database servers having databases thereon capable of being associatively accessed to determine the status of an object distributed over a plurality of said databases;
3) said computer system being configured and controlled to carry out a method of processing, tracking, and fulfilling orders for multi-component, fabricated articles and comprising the steps of:
a) entering an order for a plurality of the multi-component, fabricated articles into a database;
b) virtually associating the ordered plurality of the multi-component, fabricated articles to a virtual transit container corresponding to a real transit container;
c) transmitting the order for the plurality of the multi-component fabricated articles to a sourcing agent;
d) the sourcing agent virtually associating individual ones of the ordered plurality of the multi-component, fabricated articles to their constituent components;
e) the sourcing agent ordering the constituent components from vendors;
f) a fabricator receiving the ordered constituent components;
g) the fabricator fabricating the constituent components into multi-component articles;
h) the fabricator packing the fabricated multi-components articles into the associated real transit containers; and
i) shipping the real transit containers.

23. The program product of claim 22 of processing, tracking, and fulfilling orders for multi-component, fabricated articles wherein a marketer enters the order.

24. The program product of claim 22 of processing, tracking, and fulfilling orders for multi-component, fabricated articles wherein the sourcing agent is a marketer.

25. The program product of claim 22 of processing, tracking, and fulfilling orders for multi-component, fabricated articles wherein the sourcing agent is independent of the marketer.

26. The program product of claim 24 of processing, tracking, and fulfilling orders for multi-component, fabricated articles wherein the sourcing agent is affiliated with the marketer.

27. The program product of claim 22 of processing, tracking, and fulfilling orders for multi-component, fabricated articles wherein the database is a single database.

28. The program product of claim 22 of processing, tracking, and fulfilling orders for multi-component, fabricated articles wherein the database comprises multiple databases.

29. The program product of claim 28 of processing, tracking, and fulfilling orders for multi-component, fabricated articles comprising federating the databases to track a status of an order.

30. The program product of claim 28 of processing, tracking, and fulfilling orders for multi-component, fabricated articles comprising accessing the individual databases to track a status of an order.

31. The program product of claim 22 of processing, tracking, and fulfilling orders for multi-component, fabricated articles comprising associating an order to a container, and tracking the container.

32. A computer system configured and controlled to carry out a method of receiving orders for multi-component, fabricated articles from purchasers, and processing, tracking, and fulfilling orders for multi-component, fabricated articles from vendor networks of multiple vendors, said computer system comprising:
1) a plurality of individual computers, each individual computer having:
a) a central processor unit,
b) input/output means; and
c) local memory;
2) a plurality of database servers each of said plurality of database servers associated an individual computer, and each having databases thereon capable of being accessed by a user at one of said individual computers to:
a) enter and update the status of an object or an attribute thereof, said object having attributes distributed over a plurality of said databases;
b) determine the status of an object, including an attribute thereof; and
c) virtually pack fabricated orders into virtual shipping containers;
3) a plurality of internet servers associated to said database servers and individual computers and providing internet connectivity therebetween;
4) wherein one of said individual computers is associated to a sourcing agent, said sourcing agent receiving orders for multi-component fabricated articles, virtually associating individual ones of the ordered plurality of the multi-component, fabricated articles to their constituent components; ordering the constituent components from vendors; and virtually pack fabricated orders into virtual shipping containers; and tracking work in progress orders.

33. The Computer System of claim 32 wherein the database is a single database.

34. The Computer System of claim 32 wherein the database comprises multiple databases.

35. The Computer System of claim 32 wherein the databases are individual databases, federated to enter, update, or track a status of an order.

36. The Computer System of claim 32 for processing, tracking, and fulfilling orders for multi-component, fabricated articles including code for associating an order to a container, and tracking the container.
